(19) United States
(12) Patent Application Publication
(10) Pub. No.: US 2004/0069766 A1
(43) Pub. Date: Apr. 15, 2004

(54) DURABLE DRY HEATED FOOD SERVICE ASSEMBLY

(75) Inventors: Hans Haasis, Downey, CA (US); Donald Hyatt SR., Downey, CA (US); Donald Hyatt JR., Downey, CA (US)

Correspondence Address: OPPENHEIMER, WOLFF & DONNELLY LLP, 840 Newport Center Drive, Suite 700, Newport Beach, CA, 92660, US

(73) Assignee: Omniteam, Inc.

(21) Appl. No.: 10/271,476

(22) Filed: Oct. 15, 2002

(51) Int. Cl. F27D 11/00

(52) U.S. Cl. 219/433; 219/486

(57) ABSTRACT

A food service assembly for heating and maintaining trays of food hot while food can be served therefrom has a well for holding the tray or trays of food, the well including side walls of stainless steel, a relatively thick bottom plate made of a highly thermally conductive material such as aluminum for spreading heat out within the well, a resistive heating blanket affixed to the underside of the base plate for heating the base plate, the heating blanket covering most of the underside of the base plate, a layer of high temperature insulation such as ceramic fiber mat underneath the heating blanket and within the side walls, and a layer of insulating material such as phenolic sheet material insulating the side walls from the top surface of the assembly near the well.

### RELATED APPLICATIONS

None.

### FIELD OF THE INVENTION

This invention relates to food service wells for maintaining food at elevated temperatures. More particularly, the present invention relates to a durable dry heated food service assembly for restaurants, cafeterias, catered events and the like, for maintaining food at elevated temperatures while allowing food to be served from the trays.

### BACKGROUND OF THE INVENTION

Up to the present time, commercial food service wells for maintaining pans of food at elevated temperatures have either used heated pans of water in the wells, used CALROD® type exposed heating elements, or have used a burning fuel such as STERNO®.

Heated water units include water level sensors and temperature sensors, and the exposure to water frequently causes corrosion and malfunctions. In addition, other problems such as bacteria, water leakage and dry-out are encountered. Regarding CALROD® type units, commercially available units have a limited lifetime, and are limited in the temperature level which may be obtained and the uniformity of heating which may be provided.

Burning fuel type units present certain inherent safety hazards, and require that the cans of fuel be stocked and transported to and from the site where the food will be served.

### SUMMARY OF THE INVENTION

Objects of the present invention are to overcome problems outlined above, and to provide a durable, long lasting food service pan heating assembly particularly for use in restaurants, in cafeterias, at catered events and the like, which is capable of heating food pans evenly, and to the highest desired temperatures.

In accordance with one illustrative embodiment of the invention, a food service pan and dry well assembly includes a well that opens upwardly for receiving a tray or pans of food to be heated and/or held at an elevated temperature. Rather than using water within the well or CALROD® type heating elements, the well uses a rubberized heating blanket which is affixed to the underside of a relatively thick thermal distribution base plate made from a highly thermally conductive material such as aluminum. Well walls made from a suitable, easy to clean material such as stainless steel have rounded bottoms and blend smoothly into notches in the base plate, such that the well has no right angle cracks or other large cracks that would trap food crumbs and make the well more difficult to clean. The base plate can be coated with a nonstick or cleanable surface such as enamel or TEFLON®. Outside of the interior walls are exterior walls, with a high temperature insulation material such as ceramic fiber insulation between the internal and external walls. At the top of the well there is an upper ridge or lip which allows the well to be suspended within a suitable cutout in a counter top, and also allows one or more trays of food to be placed into and suspended in the well. In the preferred embodiment the food trays are suspended above the base plate such that there is an air gap separating the hot base plate from the trays of food, to help regulate the heat transfer rate and thus prevent burning of the food in the trays.

In one aspect therefore, the invention includes an upwardly opening tray compartment for holding a tray or pans of food such that the food can be served from the tray while the tray is in the tray compartment, the tray compartment having a peripheral rim, a substantially horizontal base plate made of a highly conductive metal such as aluminum, substantially vertical internal walls connected to the base plate, the internal walls being made of a second metal such as stainless steel and being significantly thinner than the base plate, the base plate being heated on its underside by a silicone rubber heating sheet having resistive heating wires embedded therein and being adhered to the base plate by vulcanization or a high temperature adhesive, the base plate having an easy to clean coating on it such as enamel or PTFE, and the internal walls of the tray compartment being thermally isolated from external walls of the assembly by a high temperature insulation material such as ceramic fiber insulation mat. The interior side walls curve inwardly and abut notches in the base plate to form a curved, easy to clean bottom of the well. The assembly defines a dry well which maintains trays of food hot without using any liquid that could corrode the interior of the well.

Exemplary embodiments of the invention will be further described below with reference to the drawings, in which like numbers refer to like parts.

### BRIEF DESCRIPTION OF THE DRAWINGS

FIG. 1 is a perspective, partially exploded view showing a food serving counter with a cutout into which the food service well according to one embodiment of the present invention has been placed.

FIG. 2 is a cutaway side view of the well of the present invention in conjunction with a temperature controller taken along a transverse axis.

FIG. 3 is a closeup of the area indicated in FIG. 2.

FIG. 4 is a further closeup showing how the corner of the base plate shown in FIG. 3 would appear by itself.

FIG. 5 is a closeup of the area indicated in FIG. 2.

FIG. 6 is a cutaway side view of the well of the present invention taken along a lateral axis.

### DETAILED DESCRIPTION OF EXEMPLARY EMBODIMENTS

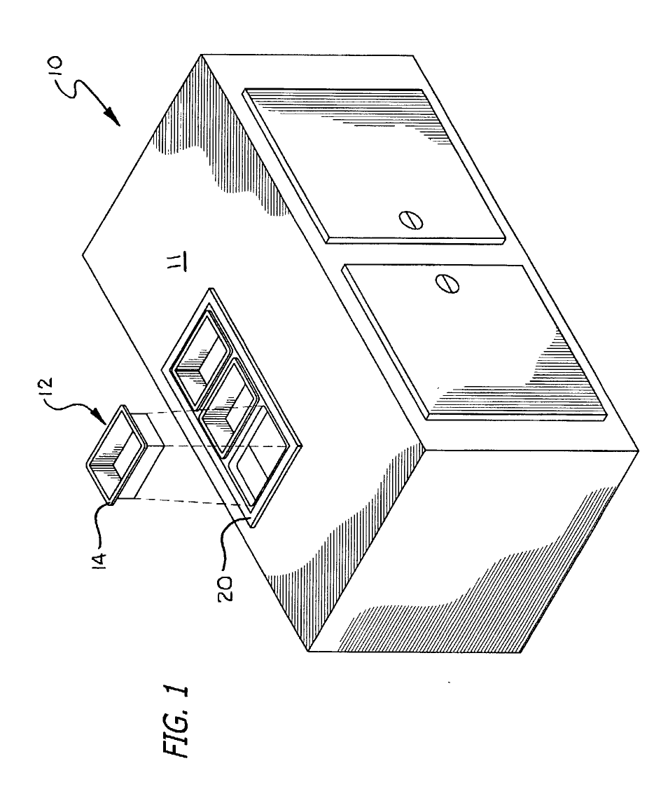

FIG. 1 shows the food service assembly or dry well 20 according to one embodiment of the present invention inserted into a suitably sized opening within horizontal counter top 11, of food serving counter 10. As can be seen, a rim or lip of assembly 20 is larger than the opening such that assembly 20 is suspended within the opening of the counter at the correct height for food to be served from food trays 12. Similarly, rims or lips 14 of the food trays or pans 12 extend at least partially over the rims or lips of the assembly 20 such that the food trays are suspended within the assembly well. In the figure, assembly 20 is arbitrarily depicted as holding three food trays. The present invention can be used to construct dry wells carrying one, two, three, or any desired number of food trays. Additionally, counter 10 can take any configuration, being a counter with solid walls and cupboard type doors as shown in the figure, a simple flat counter surface mounted on a plurality of legs, or various other types of counters and working surfaces as are commonly used within the food service industry. Alternatively, the well could be a portable standalone device for placing on top of a flat surface such as a counter or table, or could be mounted on legs with or without rollers for rolling the well to a place that it will be used. The well could also have an attached shelf for placing thereon a food tray lid, serving utensils, napkins, or other objects. In short, many configurations for the assembly are possible.

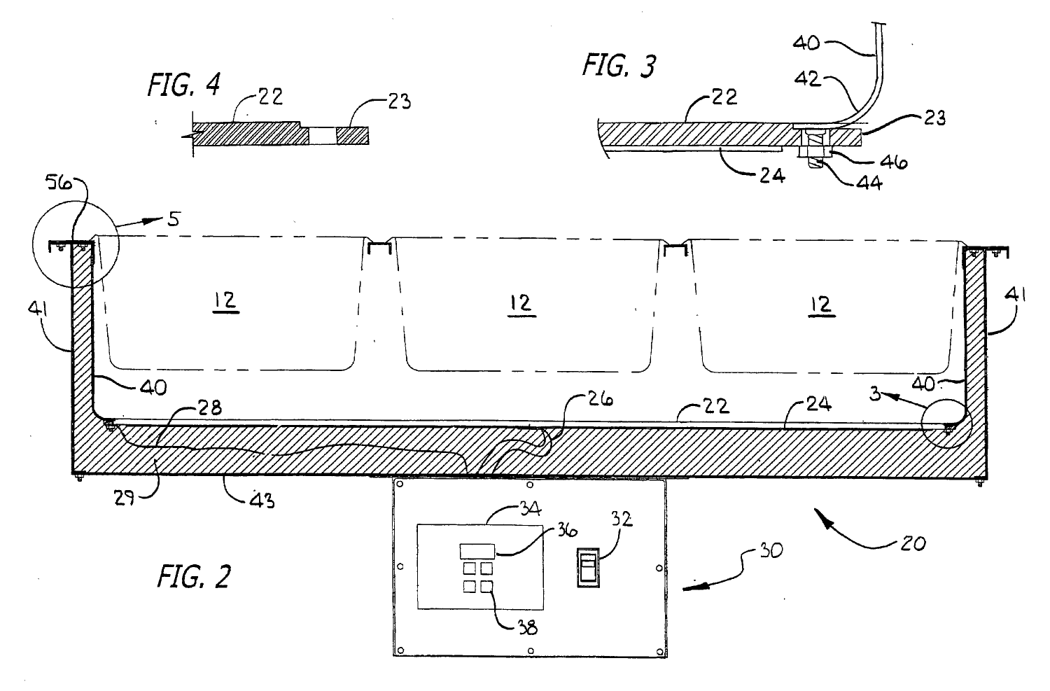

FIG. 2 is a cutaway side view of the well taken along a transverse axis, and showing additional features of one embodiment including the front panel of controller 30. Assembly 20 includes a relatively thick thermally conductive base plate 22 and internal side walls 40. External walls 41 and 43 and peripheral rim 56 complete the shell of the assembly. Insulating material 29 thermally separates the internal walls 22 and 40 from the external walls 41 and 43, respectively, thus allowing a high well temperature while keeping the external wall of the assembly at a much cooler and safe temperature. A resistive heating blanket 24 is affixed to the underside of base plate 22 and is thus in thermal conductive contact with it. Electrical lead wires 26 provide electrical current from controller 30 to heating blanket 24 to heat the blanket 24, and safety ground lead wire 28 provides a safety ground connecting the metal body of assembly 20 preferably through the ground wire of the power chord and to the ground bus of the building. A plurality of food serving trays 12 is shown in phantom. The trays are suspended by well dividers 41 which support the lips of the several food trays 12.

With respect to the base plate 22 that forms the bottom of the well, the base plate is preferably made of a highly conductive material such as aluminum or copper, and is relatively thick. In the exemplary embodiment base plate 22 is aluminum or aluminum alloy. Alternatively it can be made of copper or other highly thermally conductive material. It is preferably at least 0.25 cm (0.1 in.) thick, and more preferably approximately 6.3 mm (0.25 in.) thick. A thick base plate 22 helps to ensure that heat will be dissipated quickly and uniformly over the surface area of base plate 22. To ensure even heat distribution, preferably base plate 22 has a surface area which is at least one quarter of the surface area of the entire well bottom, more preferably at least one half of the entire well bottom, and most preferably ninety percent or more of the surface area of the well bottom, which is slightly larger than the surface area of combined surface areas of the food service trays that will be placed within the well. In the exemplary embodiment the surface area of the base plate 22 exceeds the combined surface areas of the bottoms of food trays 12. Base plate 22 need not necessarily be a single monolithic plate, but may be comprised of two or more different plates appropriately integrated into the bottom of the well. For ease of cleaning and for aesthetic purposes, base plate 22 can be provided with a non-stick or easily cleanable surface such as an enamel, ceramic, or TEFLON® coating on its top surface.

Heating blanket 24 in the exemplary embodiment is a silicone rubber heating blanket, made from a fiberglass reinforced silicone sheet material with electrical resistance heating wire imbedded therein. Heating blankets of this type have been previously used in industrial applications such as industrial processes, and are available from Benchmark Thermal Corporation of Grass Valley, Calif. Heating blanket 24 is adhered or affixed to the base plate, such as by vulcanization or by using a high temperature adhesive such as a silicone adhesive. Alternatively, heating layer 24 could be biased against base plate 22 by a biasing mechanism such as a spring, or by hold-down clips or clamps firmly held to base plate 22 by screws or other fasteners. In order to ensure rapid and consistent heat distribution throughout base plate 22, heat blanket 24 preferably covers at least one quarter of the surface area of the underside of base plate 22, more preferably covers at least one half of the surface area, and more preferably covers at least three quarters of the surface area of the underside of base plate 22. Heating sheet 24 could also be other types of heating layers or sheets including resistive thin films, such as are known within the art of heating materials. In order to ensure that the food trays 12 can be kept as hot as desirable for use within the food service industry, heating blanket 24 should be a high temperature heating blanket capable of maintaining and withstanding sustained temperatures of at least 300 degrees F. without significant degradation. In the exemplary embodiment, heating blanket 24 can withstand temperatures of over 400 degrees F.

The insulation 29 used in the exemplary embodiment is a ceramic fiber mat insulation known in the trade as K-LITE™, and which is available from Great Lakes Textiles, Inc. of Walton Hills, Ohio. The insulation fills the space between the heating blanket 24 and the exterior bottom wall 43, as well as the spaces between interior substantially vertical side walls 40 and exterior substantially vertical side walls 41. Other well known insulation materials could be used, although the insulation material should be capable of withstanding sustained temperatures next to the heating blanket 24 that are high enough to maintain the food trays 12 at approximately 200 degrees F. Thus, the insulation material should be capable of withstanding sustained temperatures of at least 500 degrees F. without significant degradation or production of harmful or noxious odors or gasses.

Interior side walls 40 should be a relatively easy to clean metal such as stainless steel, or have an easy to clean coating on it. The interior side walls 40 do not need to conduct heat rapidly, so they can be made much thinner than the base plate 24. In the exemplary embodiment, vertical side walls 40 are approximately 1.5 mm (0.06 in.) thick. Thus, base plate 22 is preferably at least twice as thick as the side walls 41, more preferably at least three times as thick as the side walls, and most preferably still at least four times as thick as the side walls, and made of a different metal than side walls 41. Expressed differently, interior wall 40 is preferably less than 3.0 mm in nominal thickness and well bottom 24 is preferably greater than 3.0 mm in nominal thickness; more preferably, the interior wall is less than 2.0 mm in nominal thickness and the well bottom is greater than 5.0 mm in nominal thickness. Exterior side walls 41 and exterior bottom wall 43 need not be made of the same material as the interior walls. Although stainless steel is aesthetic and easily cleaned, exterior walls 41 and 43 could be made of a less expensive material such as galvanized steel or plastic, inasmuch as in the embodiment shown in FIG. 1 the exterior walls will be seldom seem and will seldom require cleaning. In the case of a freestanding unit for a counter or table top, or mounted on legs, stainless steel exterior walls would be desirable.

FIG. 3 shows in detail the interface between base plate 22 and interior side wall 40 in the exemplary embodiment. Interior wall 40 has a concavely rounded bottom edge 42. Rounded bottom edge 42 fits onto notch 23 in base plate 22, and is affixed thereto such as with a fastener such as screw or bolt 44 and nut 46. The rounded bottom edge 42 of the side wall mates with notch 23 such that the side walls 40 smoothly blend into the bottom of the well substantially without any ledge or drop-off, or crack that would make cleaning difficult. Preferably each interior wall 40 has a bottom edge that smoothly transitions to base plate 22, such that the well includes two pairs of opposed side walls that smoothly transition to base plate 22 substantially without cracks or ledges in the transition area. FIG. 4 shows just the base plate 22 of FIG. 3.

One advantage of the present invention over other units that are commercially available is that it allows food to be heated more evenly. By spreading the heat out over the highly thermally conductive aluminum base plate, the heat is not concentrated in particular areas as with previous dry well units based on CALROD® type heating elements, but is spread out much more evenly. This helps to prevent relative hot and cold spots from forming in the tray of food. An additional advantage of the food service well of the present invention is that it allows products to be kept significantly hotter. Trays of food can be heated to approximately 200 degrees F., which is significantly hotter than known dry units which employ CALROD® type heating elements. One of the reasons that the food may be maintained at such a high temperature using the food service well of the present invention is the relatively even heat distribution of the heating blanket acting in combination with the even heat distribution made possible by the aluminum base plate. Without even heat distribution, hot spots that would burn the food would present an upper limit on the average food temperature which could be obtained and maintained. The present invention largely eliminates hot spots, thus allowing the food tray to be heated more evenly and thus held at a higher average temperature. Additionally, by presenting a large surface area over which convection and radiation can occur, the average temperature of the exposed heating element or elements can be significantly lowered while still maintaining the same temperature in the dry well. For example, in order to maintain a food tray temperature of approximately 200 degrees F., the base plate need be only approximately 400 degrees F. This presents a lower risk of severe burns to humans, and risk of fire should objects fall onto the base plate, than if exposed heating rods were used to heat food to the same 200 degrees F. For these and other reasons, commercially available food service assemblies for heating and holding trays of food while food is being served therefrom are more limited in their ability to maintain food temperatures.

In FIG. 2, temperature controller 30 controls the temperature of the unit. Controller 30 could be an open-loop controller, but preferably is a close-loop controller utilizing a temperature sensor (not shown) attached to base plate 24 to sense its temperature, or a sensor for sensing the air temperature within the well. In the figure controller 30 includes an on-off switch 32, a panel 34, a temperature readout 36, and a plurality of control buttons 38 for setting and/or adjusting the temperature by controlling the amount of electrical energy dissipated by heating blanket 24. Other temperature sensors are possible and well known within the art. In the exemplary embodiment, the steady state temperature differential between the food tray 12 and the base plate 24 is approximately 150 degrees F., so the offset between the control temperature and the sensed temperature is greater than 100 degrees F.

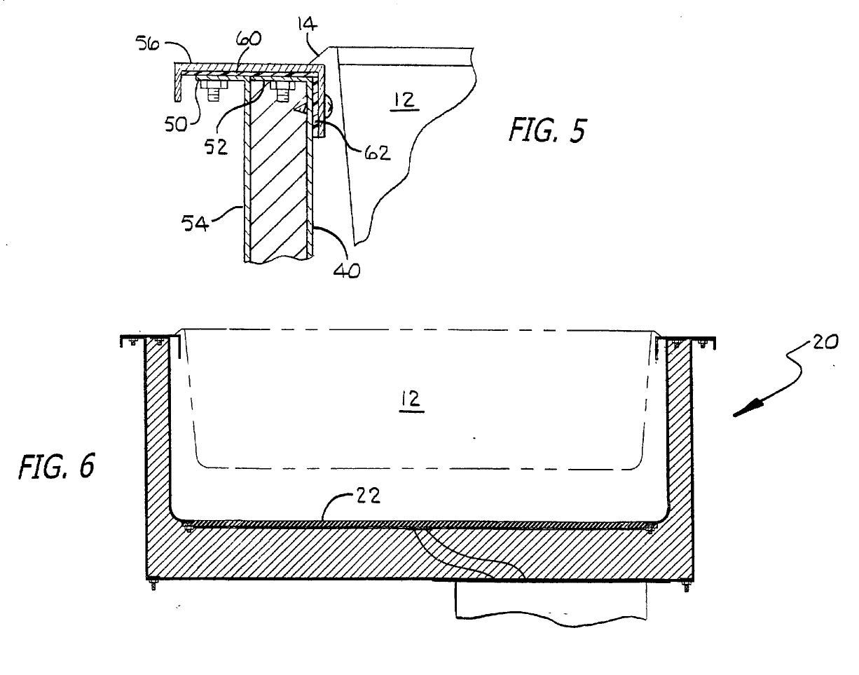

FIG. 5 is a cutaway of the upper left edge of the assembly shown in FIG. 2. In the embodiment, the upper edge is formed by inner side wall 40 which has a top portion bent at a 90 degree angle to form a first L-bracket, and outer wall 54 also has a top portion bent at a 90 degree angle to form a second L-bracket. An upper ridge or lip 56 is defined by a channel like member which is bolted, welded, or otherwise affixed to the top section 50 of exterior side wall 54, and the top section 52 of interior side wall 40, and which covers at least an upper portion of inside wall 40. Two sheets of insulating material 60 and 62 thermally insulate the ridge 56 from side wall 40 and its upper portion 52, thus keeping exposed ridge 56 at a safe temperature that is significantly lower than the temperature of side wall 40. Ridge or lip 14 of food tray 12 rests on ridge 56, suspending the food tray within the well, preferably separated from base plate 22 by an air gap across which heat flows via convection and radiation without an intervening fluid such as water. Alternatively, food trays 12 could rest directly on base plate 22. Upper ridge 56 need not be shaped as shown in the figures, and need not necessarily be even a separate piece from vertical walls 41 and/or 40. For example, in the case of a portable and free standing food service well for use at catered events and the like, upper ridge 56 could be simply a rounded top portion of the same sheet of continuous metal used to form both interior wall 40 and exterior wall 41.

FIG. 6 is a cutaway side view showing the well assembly of FIG. 2, but taken along a transverse rather than horizontal axis. The wire leads to the controller, which is shown in fragment, are visible.

It will be appreciated that the term “present invention” as used herein should not be construed to mean that only a single invention having a single essential element or group of elements is presented. Although the present invention has thus been described in detail with regard to the preferred embodiments and drawings thereof, it should be apparent to those skilled in the art that various adaptations and modifications of the present invention may be accomplished without departing from the spirit and the scope of the invention. For example, other types of heaters and insulators can be used, the dry well could be constructed in a variety of different forms, and could hold a variety of different pans, with the pans possibly containing materials other than food. Some of the construction techniques disclosed could also be applied to a fluid containing well. Accordingly, it is to be understood that the detailed description and the accompanying drawings as set forth hereinabove are not intended to limit the breadth of the present invention, which should be inferred only from the following claims and their appropriately construed legal equivalents.

What is claimed is:

1. A dry warmer and heater for trays of food for use in restaurants, cafeterias, and the like, comprising:
four substantially vertical walls, said walls connected to form an upwardly opening receiving well for holding a food tray, each wall defined by a respective internal wall, an external wall, and a first thermally insulating material therebetween;
an assembly bottom wall connected to the four external walls;
a well bottom connected to said four internal walls and disposed above said assembly bottom wall;
a resistive heating sheet disposed on an underside of said well bottom plate and affixed thereto;
a high temperature insulating material disposed between said assembly bottom wall and said well bottom plate, said high temperature material capable of withstanding temperatures of greater than 500 degrees F.;
a separately formed channel member which covers an uppermost extension of said external walls and at least an uppermost extension of said internal walls; and
insulating sheet material disposed between said channel and said uppermost extension of said external walls, and between said channel and said uppermost extension of said internal walls.

2. A warmer and heater according to claim 1 wherein said bottom plate is at least twice as thick as said internal walls.

3. A warmer and heater according to claim 2 wherein said bottom plate is made of a different metal than said internal walls.

4. A warmer and heater according to claim 3 wherein said bottom plate is comprised of metal selected from the group consisting of aluminum and copper, and said internal walls are comprised of stainless steel.

5. A warmer and heater according to claim 1 wherein said high temperature insulating material is a ceramic fiber material.

6. A warmer and heater according to claim 1 further comprising a food serving counter, said counter having a hole therein adapted for receiving and holding said warmer and heater.

7. A warmer and heater according to claim 1 wherein said heating sheet comprises a fiberglass reinforced silicone rubber sheet having resistive elements embedded therein.

8. A food service assembly comprising:
a peripheral rim, said rim connected to an upwardly opening tray compartment therein for holding a food tray such that food can be served from said tray while said tray is in said tray compartment, said tray compartment including:
a substantially horizontal base plate made of a first metal; and
a plurality of substantially vertical internal walls connected to said base plate, said vertical walls being thinner than said base plate and made of a second metal different from said first metal.

9. A food service assembly according to claim 8 wherein:
said base plate is greater than 3.0 mm in nominal thickness; and
said vertically internal walls are less than 3.0 mm in nominal thickness;

10. A food service assembly according to claim 8 further comprising:
a plurality of substantially vertical external walls connected to said rim, said external walls being made of a third material different from said first and second metals.

11. A food service assembly according to claim 8 wherein said vertical internal walls have concavely rounded bottom edges, said rounded bottom edges abutting notches in said base plate to thereby define opposing walls which each smoothly transition to said base plate substantially without any ledges therebetween.

12. A food service assembly according to claim 8 further comprising:
a silicone heating blanket affixed to an underside of said base plate.

13. A food service assembly according to claim 11 wherein said first metal comprises aluminum and said second metal comprises stainless steel.

14. A food service assembly according to claim 13 wherein said aluminum base plate includes a nonstick coating on a top surface thereof.

15. A food service assembly according to claim 13 further comprising at least one food tray placed within said tray compartment, wherein said food tray is warmed by heat transfer from said base plate to said tray without an intervening liquid therebetween.

16. A food service assembly according to claim 8 further comprising a counter having a counter surface and at least two sides, said counter surface having a hole therein adapted for receiving and holding said food service assembly.

17. A dry heating apparatus for keeping trays of food hot comprising:
a generally vertically well comprising a bottom wall and a plurality of side walls connected thereto and rising upwardly therefrom, said well being configured to receive and hold at least one food tray above said bottom wall and spaced apart therefrom;
said bottom wall having a top surface and an underside, and being made of a different material than said side walls;
a resistive heating sheet in conductive contact with said bottom wall, said resistive heating sheet capable of being heated and held at at least 300 degrees F.;
a horizontal edge connected to said vertical walls for resting a lip of said food tray thereon thereby suspending said food tray within said well, said horizontal edge being separated from said vertical walls by a layer of thermal insulation; and
a controller for varying the amount of heat generated in said resistive heating element thereby controlling the temperature within said well;
wherein said dry heating well transfers heat across an air gap between said bottom wall and said food tray without an intervening reservoir of liquid therebetween.

18. A warmer and heater according to claim 17 wherein said heating sheet comprises fiberglass reinforced silicone, said sheet being vulcanized to said bottom wall.

19. A dry heating apparatus according to claim 17 wherein said bottom wall is at least twice as thick as said side walls.

20. A dry heating apparatus according to claim 19 wherein said bottom wall comprises a metal selected from the group consisting of aluminum and copper, and said side walls comprise stainless steel.

21. A dry heating apparatus according to claim 17 wherein said side walls have concavely rounded bottom edges, said rounded bottom edges abutting notches in said bottom wall to thereby define pairs of opposing walls which each smoothly transition to said bottom wall substantially without any ledges therebetween.

22. A dry heating apparatus according to claim 21 wherein said bottom wall is at least three times as thick as said side walls.

23. A dry heating apparatus according to claim 17 wherein said resistive heating layer is adhered to an underside of said bottom wall and covers at least fifty percent of said bottom wall underside.

24. A dry heating apparatus according to claim 23 further comprising an insulating layer underneath said resistive heating layer, said insulating layer comprising a mat of ceramic fibers.

25. A dry heating apparatus according to claim 23 further comprising a temperature sensor which senses a temperature of said bottom wall, said temperature sensor interfacing with said controller.

26. A dry heating apparatus according to claim 25 wherein said temperature controller has an interface for a user to select a desired temperature, and wherein said controller controls the heating layer to maintain its temperature at more than 100 degrees F. above the selected desired temperature.

27. A dry heating apparatus according to claim 17 further comprising a food serving counter, said counter having a hole therein adapted for receiving and holding said dry heating apparatus.
